(19) United States
(12) Patent Application Publication
(10) Pub. No.: US 2019/0345615 A1
(43) Pub. Date: Nov. 14, 2019

(54) LASER DEPOSITION PROCESSES FOR COATING ARTICLES

(71) Applicant: Polskie Zaklady Lotnicze SP. Z.O.O., Mielec (PL)

(72) Inventors: Adam Dworak, Baranow Sandomierski (PL); Piotr Koruba, Wroclaw (PL); Piotr Jurewicz, Wroclaw (PL)

(21) Appl. No.: 16/133,945

(22) Filed: Sep. 18, 2018

(30) Foreign Application Priority Data
May 14, 2018 (EP) 18451556.5

(51) Int. Cl. C23C 24/10; B32B 15/01; C22C 19/07; B64F 5/10; B64C 25/60; B23K 26/354

(52) U.S. Cl. CPC C23C 24/106; B32B 15/013; C22C 19/07; F16F 9/3221; B64C 25/60; B23K 26/354; B32B 2605/18; B64F 5/10

(57) ABSTRACT

A process of coating a metallic article comprises depositing a metallic coating powder to a surface of a metallic article; applying an energy beam to the deposited metallic coating powder to at least partially melt the metallic coating powder while moving the energy beam and/or the metallic article to have a relative velocity of at or between about 15 meters/minute to about 60 meters/minute; and cooling the melted metallic coating powder to form a coating layer on the surface of the metallic article.

### CROSS-REFERENCE TO RELATED APPLICATIONS

The present application claims priority from European Patent Application No. 18461556.5, filed May 14, 2018. The contents of the priority application are hereby incorporated by reference in their entirety.

### BACKGROUND

The present disclosure relates to processes of coating metallic articles and more particularly, laser deposition processes of coating metallic articles to protect the articles against corrosion and abrasion. The present disclosure also relates to coated articles having improved corrosion and wear resistance.

In the aviation industry, parts are often used under load in harsh environments. To extend their service life, these parts can be covered with various coatings. The most commonly used coating is a hard chromium coating formed by galvanic methods. However, chromium coatings deposited by galvanic methods can be porous, which may lead to the corrosion of the parts over time. In addition, chromium coatings do not form strong chemical bonds with metal substrates. Thus under challenging conditions, delamination can occur reducing the lifetime of the hard chromium coating. Further, galvanic processes, including hard chrome plating, can cause hydrogen embrittlement within the coating, which may reduce the fatigue strength of the coating by up to 50% and limits the possibility of using the process to recoat used parts that have previously been coated with chromium coatings. Therefore materials and processes that are effective to improve the reliability and long-term performance of the coatings on metallic articles would be well-received in the art. It would be a further advantage if such processes can be used to refurbish used parts.

### BRIEF DESCRIPTION

According to one embodiment, a process of coating a metallic article comprises depositing a metallic coating powder to a surface of a metallic article; applying an energy beam to the deposited metallic coating powder to at least partially melt the metallic coating powder while moving the energy beam and/or the metallic article to have a relative velocity of at or between about 15 meters/minute to about 60 meters/minute; and cooling the melted metallic coating powder to form a coating layer on the surface of the metallic article.

In addition to one or more of the features described above, or as an alternative, in further embodiments the energy beam is a laser.

In addition to one or more of the features described above, or as an alternative, in further embodiments the metallic coating powder is fed coaxially with the energy beam.

In addition to one or more of the features described above, or as an alternative, in further embodiments the coating layer has a thickness of about 10 microns to about 100 microns.

In addition to one or more of the features described above, or as an alternative, in further embodiments greater than 50 wt. % of the metallic coating powder is melted by the energy beam.

In addition to one or more of the features described above, or as an alternative, in further embodiments the metallic coating powder is at least partially melted before contacting the surface of the metallic particle.

In addition to one or more of the features described above, or as an alternative, in further embodiments the process further comprises forming additional coating layers by: depositing additional metallic coating powder to the coating layer formed on the surface of the metallic article; applying a second process energy beam to the additional metallic coating powder to at least partially melt the additional metallic coating powder while moving the energy beam and/or the metallic article to have a relative velocity of at or between about 15 meters/minute to about 60 meters/minute; and cooling the melted additional metallic coating powder to form additional coating layers on the metallic article.

In addition to one or more of the features described above, or as an alternative, in further embodiments the process comprises forming no more than three coating layers on the surface of the metallic article.

In addition to one or more of the features described above, or as an alternative, in further embodiments the metallic coating powder comprises, based on the total weight of the metallic coating powder, about 50 to about 70 wt. % of cobalt; and about 20 to 40 wt. % of chromium.

In addition to one or more of the features described above, or as an alternative, in further embodiments the metallic coating powder comprises, based on the total weight of the coating powder, about 55 to 64 wt. % of cobalt; about 26 to 30 wt. % of chromium; about 1.2 to 3 wt. % of silicon, about 1 to about 1.3 wt. % of a carbide, and about less than 3 wt. % of iron.

In addition to one or more of the features described above, or as an alternative, in further embodiments the metallic coating powder comprises particles having a size within the range of about 10 to about 100 microns.

In addition to one or more of the features described above, or as an alternative, in further embodiments the metallic article is formed from one or more of the following: an iron-based alloy; a cobalt-based alloy; or a tungsten-based alloy.

In addition to one or more of the features described above, or as an alternative, in further embodiments the metallic article comprises about 90 to about 99.5 wt. % of iron based on the total weight of the metallic article.

In addition to one or more of the features described above, or as an alternative, in further embodiments the energy beam has a linear energy of about 2×10⁻³ kJ/mm to about 10×10⁻³ kJ/mm.

In addition to one or more of the features described above, or as an alternative, in further embodiments the process further comprises heat treating the coated metallic article.

According to another embodiment, a coated article is manufactured by the above-described process.

According to yet another embodiment, an aircraft component comprises a substrate containing an iron-based alloy; a coating disposed on a surface of the substrate, the coating being formed from a metallic powder comprising, based on the total weight of the metallic powder, about 50 to about 70wt % of cobalt; and about 20 to 40 wt. % of chromium.

In addition to one or more of the features described above, or as an alternative, in further embodiments the coating has no more than three coating layers, each coating layer having a thickness of about 10 to about 100 microns.

In addition to one or more of the features described above, or as an alternative, in further embodiments the aircraft component is an aircraft landing gear component.

According to still another embodiment an aircraft comprises the above described aircraft component.

The foregoing features and elements may be combined in various combinations without exclusivity, unless expressly indicated otherwise. These features and elements as well as the operation thereof will become more apparent in light of the following description and the accompanying drawings. However, it should be understood that the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiments. The drawings that accompany the detailed description can be briefly described as follows:

FIG. 1 is a schematic view of a high speed laser deposition station;

FIG. 2 shows an ERBA Compact 300 universal lathe;

FIG. 3 illustrates a laser deposition process;

FIG. 4 is a side view of a part coated via a laser beam moved at a speed of 50 meters/minute;

FIG. 5 is a cross-sectional view of a coating deposited via a laser beam moved at a speed of 50 meters/minute;

FIG. 6 shows the distribution of microhardenss HV0.1 as a function of the number of coating layers;

FIG. 7A, FIG. 7B, FIG. 7C, and FIG. 7D illustrate various defects of a coating formed by a high speed laser deposition process;

FIG. 8 is a cross-sectional view of a three-layer STELLITE 6 coating formed by a high speed laser deposition process;

FIG. 9A shows a piston rod with STELLITE 6 coating deposited by a low speed laser deposition process, and FIG. 9B shows an M 28 piston rod with a STELLITE 6 coating deposited by a high speed laser deposition process;

FIG. 10A and FIG. 10B are pictures of a piston rod coated with STELLITE 6 by a high speed laser deposition process;

FIG. 11A and FIG. 11B are pictures of landing gears having coated piston rods thereon; and

FIG. 12 is a side view of a rotary wing aircraft.

The detailed description explains embodiments of the disclosure, together with advantages and features, by way of example with reference to the drawings.

### DETAILED DESCRIPTION

Aspects of the invention are directed to a processes of coating metallic substrates using high speed laser deposition. As used herein, a high speed laser deposition process means that an energy beam such as a laser beam, a metallic article to be coated, or a combination thereof are moved such that the energy beam and the metallic article to be coated have a relative velocity of greater than about 15 meters/minute to about 60 meters/minute or greater than about 18 meters/minute to about 35 meters/minute. A low speed laser deposition process means that an energy beam such as a laser beam, a metallic article to be coated, or a combination thereof are moved such that the energy beam and the metallic article to be coated have a relative velocity of less than about 13 meters/minute.

The high speed laser deposition processes provide coated articles having improved metallurgical bonding between the coating and the substrate, thus allowing for the manufacture of coated articles having improved reliability and long-term performance. In addition, the high speed laser deposition processes have high cooling rates, and allow for minimal mixing of the coating material with the substrate. Thus the coatings obtained with the processes have high purity. In addition, the obtained coatings have a low zone of heat influence, which has a direct impact on internal stresses and thermal deformations.

In addition, the high speed laser deposition processes are automated and have shortened process time as compared to galvanic coating processes or low speed laser deposition processes. Moreover, the processes disclosed herein are environmentally friendly since there is no Cr⁶⁺ involved. The processes disclosed herein have many applications, in particular, for the aviation industry. However, it is understood that other industries may benefit from aspects of the invention, such as the maritime, automotive and manufacturing industries.

A process of coating a metallic article is disclosed. The process comprises depositing a metallic coating powder to a surface of a metallic article; applying an energy beam to the metallic coating powder to at least partially melt the metallic coating powder; and cooling the melted metallic coating powder to form a coating layer on the surface of the metallic article, wherein the energy beam, the metallic article, or a combination thereof are moved such that the energy beam and the metallic article have a relative velocity of greater than about 15 meters/minute to about 60 meters/minute, or greater than about 18 meters/minute to about 35 meters/minute, or greater than about 18 meters/minute to about 25 meters/minute. An exemplary process is illustrated in FIG. 3.

The metallic articles to be coated can be used without surface processing or can be processed, including chemically, physically, or mechanically treating the articles. For example, the articles can be treated to roughen or increase a surface area of the articles, e.g., by sanding, lapping, or sand blasting. A surface of the articles can also be cleaned to remove contaminants through chemical and/or mechanical means.

The metallic articles can be formed from an iron-based, a cobalt-based alloy, a tungsten-based alloy, etc. As used herein, the term “metal-based alloy” means a metal alloy wherein the weight percentage of the specified metal in the alloy is greater than the weight percentage of any other component of the alloy, based on the total weight of the alloy. Preferably, the metallic article comprises about 90 to about 99.5 wt. % of iron based on the total weight of the metallic article. In an embodiment the metallic article is formed from steel AISI 4330 AMS6411.

The metallic coating powder comprises, based on the total weight of the metallic coating powder, about 50 to about 70 wt. % of cobalt; and about 20 to 40 wt. % of chromium. Specifically, the metallic coating powder can include, based on the total weight of the coating powder, about 55 to 64 wt. % of cobalt; about 26 to 30 wt. % of chromium; about 1.2 to 3 wt. % of silicon, about 1 to about 1.3 wt. % of a carbide, and about less than 3 wt. % of iron. Commercially available metallic coating powders include STELLITE 6, MetcoClad 6F, and the like. The metallic coating powders can comprise particles having a size within the range of about 10 to about 100 microns.

The metallic coating powder can be supplied to a surface of the metallic article to be coated as the laser or other beam source is applied and moved over the surface of the metallic articles. In an exemplary process, the metallic coating powder is coaxially fed with a laser beam, and the laser beam is moved along with the powder supply as a coating layer is formed.

During a fusing process, an energy beam such as an electromagnetic beam from an energy source such as a laser is applied to the metallic powder to fuse the powder. The metallic coating powder is at least partially melted before contacting the surface of the metallic particle. In an embodiment, greater than about 50 wt. %, greater than about 80 wt. %, or greater than 80 wt. % but less than 95 wt. % of the metallic coating powder is melted by the energy beam. The energy beam can have a linear energy of about 2×10⁻³ kJ/mm to about 10×10⁻³ kJ/mm, or about 3×10⁻³ kJ/mm to about 8×10⁻³ kJ/mm.

The melted coating powder can be cooled forming a coating layer. As used herein, “layer” is a term of convenience that includes any shape, regular or irregular, having at least a predetermined thickness. The thickness of a coating layer can vary widely depending on the process parameters. In some embodiments the thickness of a coating layer as formed is about 10 microns to about 100 microns, about 10 microns to about 80 microns, or about 12 microns to about 70 microns.

More than one coating layer can be formed. Thus the processes can further comprise forming additional coating layers by: depositing additional metallic coating powder to the coating layer formed on the surface of the metallic article; applying a second process energy beam to the additional metallic coating powder to at least partially melt the additional metallic coating powder; and cooling the melted additional metallic coating powder to form additional coating layers on the metallic article. The coating can include 1 to 20 coating layers. In an embodiment, the coating has no more than three coating layers.

If needed, the coated articles can be further treated to obtain the desired surface properties. Advantageously, the processes can be used to refurbish used parts.

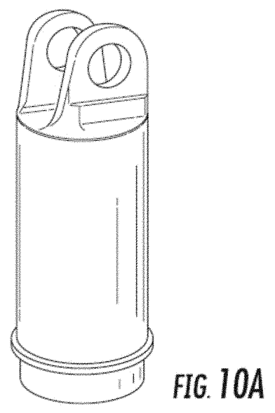

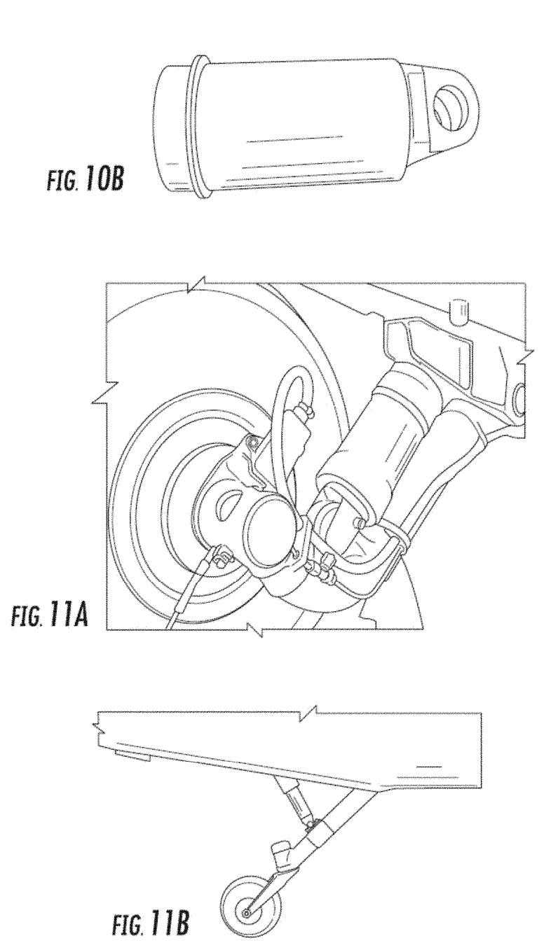

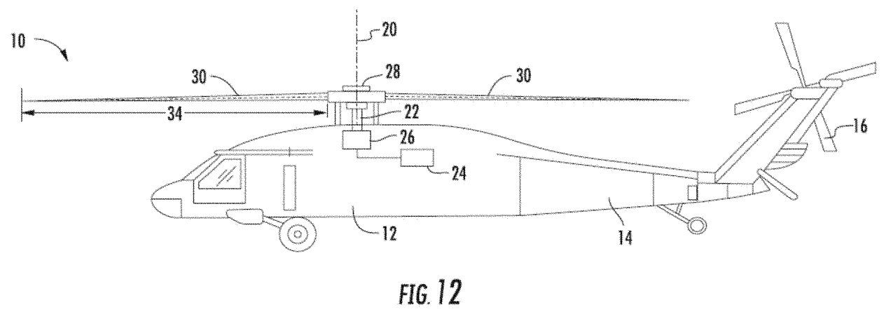

Articles coated by the processes disclosed herein are useful for a wide variety of applications including but are not limited to electronics, atomic energy, hot metal processing, aerospace, automotive, and marine applications. In an exemplary embodiment, the coated article is an aircraft component such as a landing gear component, which in some iterations is a helicopter landing gear. Illustratively, FIG. 10A and FIG. 10B are pictures of a piston rod coated with STELLITE 6 by a high speed laser deposition process. FIG. 11A and FIG. 11B are pictures of landing gears having coated piston rods thereon.

Experiments relating to the disclosed processes as well as comparative processes are described below. The coating processes are implemented on aircraft landing gear components. The results indicate that the coatings obtained by the processes disclosed herein can be competitive with hard chromium electrolytic coatings.

The first stage of the work was to develop the parameters of the process on a cylindrical element with an outside diameter of 84 mm and a length of 160 mm, which is a representation of a fragment of the piston rod of a chassis. The sleeve was made of heat treated and surface hardened steel AISI 4330 AMS6411. The chemical composition used is shown in Table 1. The MetcoClad 6F was a spheroidal powder obtained by gas atomization. The grain size was within the range of 20/53 microns.

TABLE 1
Material composition

| Element | AISI 4330 | MetcoClad 6F |
|---|---|---|
| Iron | 95.3-98.1 | ≤3.0 |
| Nickel | 1.0-1.5 | — |
| Manganese | ≤1.0 | — |
| Silicon | ≤0.8 | 1.2-3.0 |
| Chomium | 0.4-0.6 | 26-30 |
| Cobalt | — | 55-64 |
| Molybdenum | 0.6-0.5 | — |
| Wolfram | — | 3.5-5.5 |
| Carbide | 0.2-0.3 | 1.0-1.3 |
| Other | — | <1.0 |

In the experiment carried out, a station equipped with a robotic padding system was used. The applied optical system allowed for laser beam welding with a diameter of 1.5 mm at a linear speed of 20 mm/sec to show the results using the conventional low speed laser deposition process. A series of experiments were carried out, each of them with slightly modified process parameters. For the analysis of results between two successive experiments, only one parameter was modified. As a result of the process optimization, a homogeneous coating of low waviness and a thinning of 5.3% was obtained. The test results are shown in Table 2.

TABLE 2
Measurement of hardness and geometrical
properties

| High | Depth | HAZ depth | Dilution | Hardness |
|---|---|---|---|---|
| 254.8 μm | 14.2 μm | 433.6 μm | 5.3% | 596HV0.3 |

The optimization process was carried out in the form of strips of a 10 mm wide cladded coating. The coating thus obtained was cladded along the entire length of the sleeve in order to evaluate the thermal processes occurring on the surface of the heated substrate material and the effect of heating the element with a laser beam on the geometrical properties of the coating.

The coating was obtained in one pass. The height of the cladding layer decreased slightly to 224 microns. A greater amount of energy delivered to the substrate material has increased the depth of the heat affected zone to less than 700 microns. The sleeve with a laser deposited coating was subjected to a series of non-destructive tests, including MT, PT, and a porosity test with potassium ferrocyanide. For further tests, the sleeve was subjected to a sanding process to obtain Ra 0.32 and a coat thickness of 50-100 microns. The thickness of the coating after sanding was determined by the requirements for the reference coating of hard chrome and the structural requirements of the target chassis component. As a result of the tests, no cracks or discontinuities of the coating were found. The leakage test did not reveal the presence of pores through the base material. The lack of porosity also has a direct impact on the positive corrosion resistance of material deposited in the salt fog test. A series of laboratory tests were carried out to compare the properties of the obtained coating with a reference coating. To conduct additional tests, including tests of tensile strength, bending tests, fatigue strength tests, Taber wear resistance and loose abrasive, separate sets of samples were made whose shape was dictated by the test requirements. The full range of tests and the results obtained are detailed in Table 3.

TABLE 3
Comparative Test Matrix of Reference Coating of
Hard Chrome and Conventionally Coated

| | | EHC | Stellite 6 |
|---|---|---|---|
| Testing | Norm used | AMS 2460 | Conv. speed |
| Thickness (μm) | 1B-1-21 | 123-165 | 185, 254 |
| Hardness (HTV0.1) | ASTM E384 | 600-800 | 550 |
| Adhesion | PN-EN ISO 7438 | pass | pass |
| Porosity | AMS 2460 | occurs | No |
| Tensile strength | ASTM E8/E8M | 1602.9 | 1600.4 |
| [MPa] | | | |
| Salt fog Test [h] | ASTM B17-11 | 24 | Pass after 192 |
| Galvanic corrosion | PN-EN 12473 | 3.23 | 6.84 |
| test [μm/year] | | | |
| Taber wear | ASTM-D4060 | 1.56 | 2.76 |
| Resist. | | | |
| [mg/1000cycles] | | | |
| Loose abrasive | GOST23.208-79 | 1.19 | 1.05 |
| Fatigue life | ASTM-E466 (for | 15075 | 20458 |
| | 100 ksi) | | |
| NDT-MT | IJ-8.2-32 | Without | Without |
| | | Disadvantage | disadvantage |

Tests carried out on a low speed coating (20 mm/sec or 1.2 meters/minute) were compared with the test results for a galvanic hard chromium coating. STELLITE 6 coating has better properties than galvanic coating except for microhardness as well as abrasion resistance.

One of the ways of influencing these properties of the coating is to control the size of the microstructure using the cooling speed, which can be implemented by changing the cladding speed. In the case of the STELLITE 6 alloy, an increase in the welding speed results in a significant grain refinement. The experiments show that it is possible to use high speed laser deposition to produce a coating that is an alternative to plated hard chrome coating.

In the case of ultra-high speed laser cladding (UHSCL) technology, the main characteristic of the process is the application of a much higher relative velocity of beam motion and the object to be welded. After an increase in the efficiency of surfacing, this treatment also offers higher cooling rates of the applied coating material, which results in the formation of a shredded microstructure and an increase in hardness. In addition, the narrowing of the powder stream should be above the cladded element to allow the powder to partially melt before contacting the substrate. The difference between a low speed laser deposition and a high speed laser deposition include the following. For a low speed laser deposition, the energy is focused on the substrate, i.e., the metallic article to be coated, and the powder temperature can be relatively low such that the powder does not melt or less than 20 wt. % of the powder melts. For a high speed laser deposition process, the energy is focused on the powder, and the powder temperature can be relative high such that greater than 80 wt. % of the powder melts during the coating process.

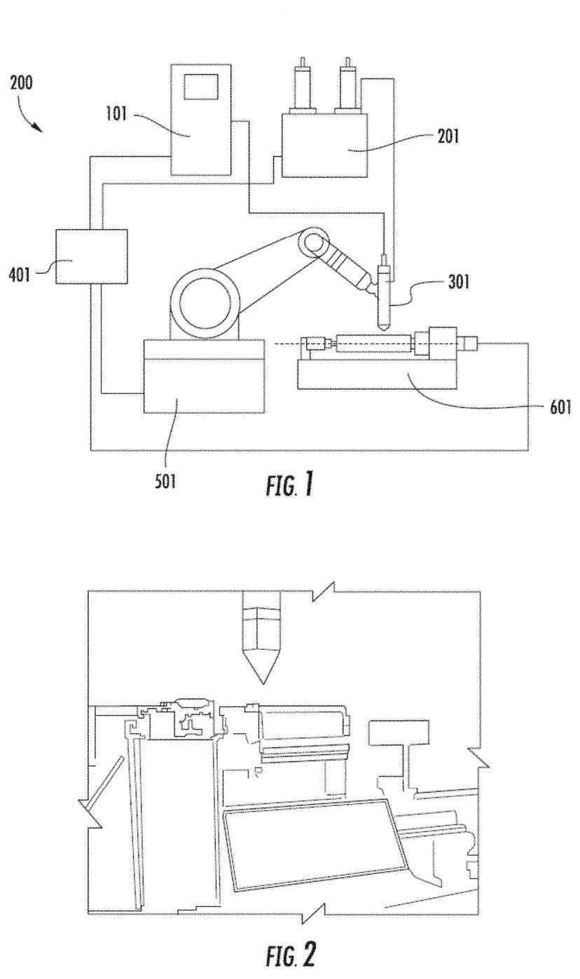

A schematic view of an exemplary system for high speed cladding is shown in FIG. 1. The system (200) includes a laser source (101), a powder feeder (201), a speed controller (301), a lathe (601), a robot controller (401), and a six-axis robot (501). In order to be able to carry out the laser deposition process at much higher speeds, it was necessary to expand the work station. In place of the REIS RDK 05 rotary table the ERBA Compact 300 universal lathe as shown in FIG. 2 was used.

The spindle speed of the lathe and the linear speed of the laser head have been coupled using a microprocessor system and the Lab View application. For correct interpretation of the tests to be carried out, the same component as for a low speed laser deposition, sleeve 84×160 mm from material AISI 4330 AMS6411 was selected for the tests. The basic parameters for verifying the process correctness were the coating without cracks, porosities and surface defects.

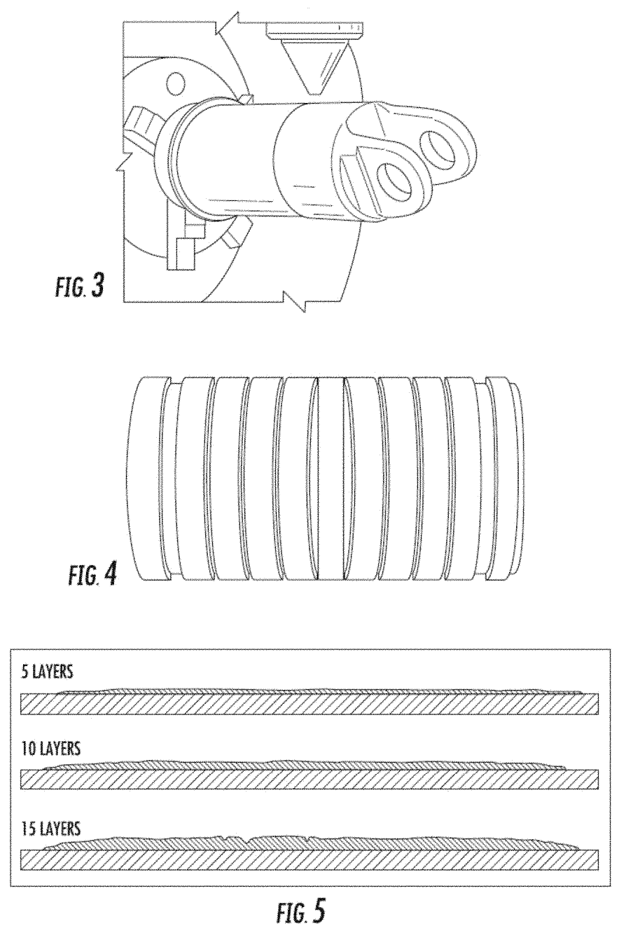

As part of the verification of the high speed laser deposition process, test coatings with a width of 12 mm were made at a speed of 50 m/min. (FIGS. 4 and 5) The optical path of shaping the laser beam has been configured in such a way as to obtain a spot in the focus of 1.5 mm. The coatings differed in the number of layers of additive material applied, the powder feed rate being 36.8 g/min. However, the powder density and linear energy were constant and were 1.7×105 W/cm² and 3.6×10⁻³ kJ/min respectively.

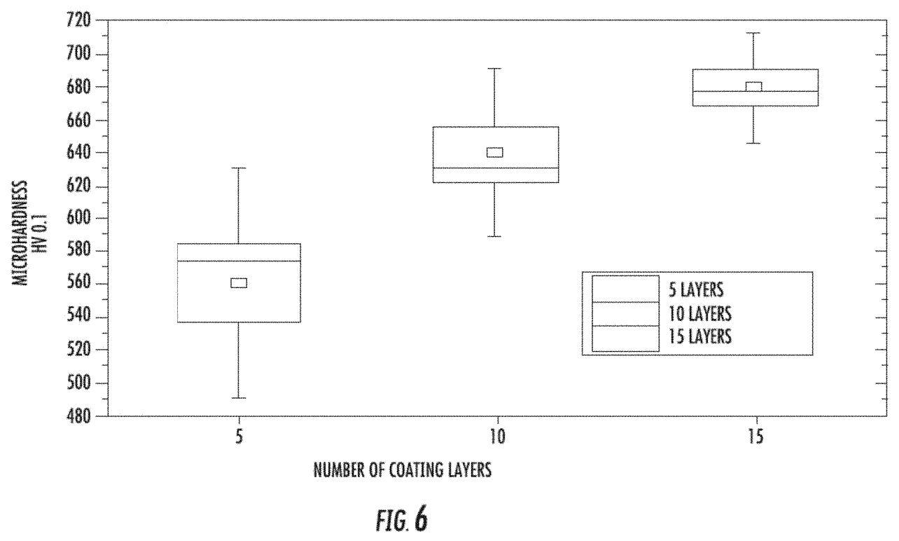

As the number of layers increases, the thickness of the coating increases, with the thickness of one layer remaining constant at 13 microns. The number of layers to be cladded also does not affect the enlargement of the heat affected zone, which is within 110-130 microns. The increase in the welding speed also increases the microhardenss of the coating. The measured average microhardness of HV0.1 increases when the number of the layers increases (FIG. 6).

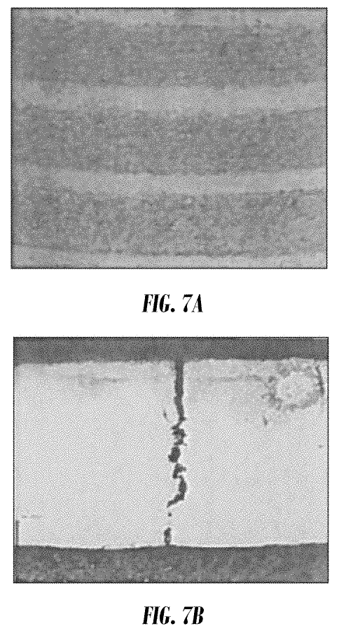

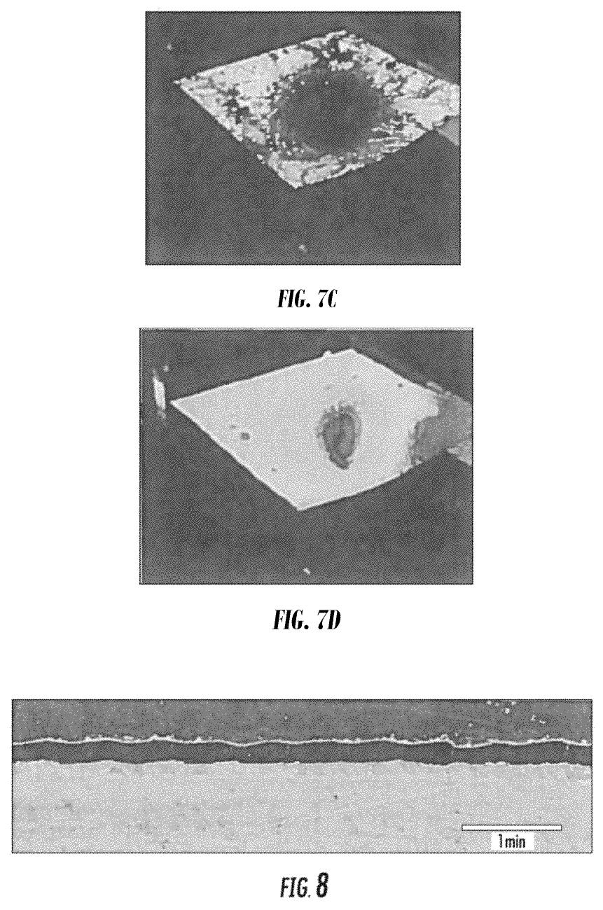

In the cladded coatings cracks were noticed (FIG. 7). As the number of layers increased, the cracks began to grow over the entire thickness of the coating up to the substrate material. The occurrence of surface defects in the form of craters is also noticeable for coatings with the largest number of layers. The fastest method to verify the quality of the coating is the penetration method. The reasons for the occurrence of this type of defect are overly rapid coagulation of the coating and overly rapid cooling of the coating. In addition, it was noted that the size and number of defects increased with the number of layers. Process optimization was carried out to eliminate the occurrence of cracks.

The welding speed was reduced to 20 m/min, therefore, the linear energy increased to 7.5×10−3 kJ/mm. The number of layers up to 3 was also limited. Metallographic decomposition (FIG. 8) of the obtained coating and penetration tests showed no cracks or surface defects.

As the powder flow was not changed, the thickness of a single coating layer increased to 70 microns. The obtained coating was cladded along the entire length of 160 mm sleeve to assess the influence of thermal processes occurring on the surface of heated substrate material and the impact of heating the element with a laser beam on the geometrical properties of the coating. As a result of the experiment, a coating was obtained with a constant layer height, without visible surface defects and cracks, which was confirmed in the penetration test.

The CRK, CRICK 120 penetrant and the CRK CRICK 130 pen-maker were used for the test. The STELLITE 6 coating obtained as a result of high speed laser cladding is characterized not only by the similar layer height, but also by a half of the lower heat affected zone and much higher microhardness at the level of 800HV0.1. In addition, the deposition time with respect to a low speed laser deposition process was reduced by almost 17 times.

A quantitative summary of both techniques is presented in Table 4.

TABLE 4

| Process | LC | UHSLC |
|---|---|---|
| Time [min] | 75 | 15 |
| HAZ depth [μm] | 690 | 288 |
| Thickness [μm] | 227 | 199 |
| HV 0.1 | ~550 | ~800 |
| Number of layers | 1 | 3 |
| Cracks | None | None |

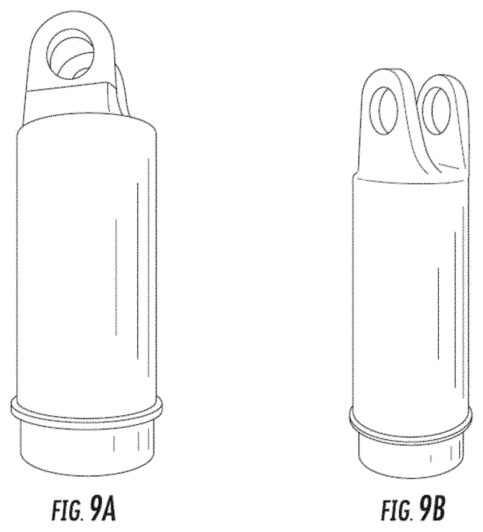

The results of the low speed laser coating and the optimization of the technology with the high speed laser deposition allow the full scale assembly of components. A test element was performed which was a mapping of the piston rod of the M 28 aircraft chassis under full scale. Experiments were conducted to assess the impact of geometry and variable sections of the part on the distribution of heat discharged during the cladding process as well as to conduct further stand tests relevant to the actual part. FIGS. 9A and 9B show the test element immediately after the laser deposition process. The component has previously been subjected to a strengthening heat treatment.

Parts coated by a high speed laser deposition process are heat treated, sanded and polished to obtain a roughness of Ra 0.16. During a magnetic test, no flaws or cracks were detected.

FIG. 12 schematically illustrates a rotary-wing aircraft 10, such as a helicopter for example, having parts cladded using the high speed laser deposition process according an aspect of the invention. The aircraft 10 includes an airframe 12 having an extending tail 14 which mounts a tail rotor system 16, such as an anti-torque system for example. Landing gear (not labelled) are attached to the airframe and are cladded using the high speed laser deposition process according an aspect of the invention. A main rotor assembly 18 is driven about an axis of rotation 20. In an embodiment, a drive shaft 22 operably couples the main rotor assembly to a power source, such as an engine (illustrated schematically at 24) for example, through a main gearbox (illustrated schematically at 26). Parts of the drive shaft 22 and main rotor assembly 18 can be cladded using the high speed laser deposition process according an aspect of the invention. The main rotor system 18 includes a plurality of rotor blades 30 mounted to a rotor hub 28. Although a particular helicopter configuration is illustrated and described in the disclosed non-limiting embodiment, other configurations and/or machines, such as high speed compound rotary wing aircraft with supplemental translational thrust systems, dual contra-rotating coaxial rotor system aircraft, multirotor, turboprops, tilt-rotors, tilt-wing aircraft, and fixed wing aircraft such as the M28 will also benefit from the present invention.

While the present disclosure is described with reference to exemplary embodiments, it will be understood by those skilled in the art that various changes may be made and equivalents may be substituted without departing from the spirit and scope of the present disclosure. In addition, various modifications may be applied to adapt the teachings of the present disclosure to particular situations, applications, and/or materials, without departing from the essential scope thereof. The present disclosure is thus not limited to the particular examples disclosed herein, but includes all embodiments falling within the scope of the appended claims.

1. A process of coating a metallic article, the process comprising:
depositing a metallic coating powder to a surface of a metallic article;
applying an energy beam to the deposited metallic coating powder to at least partially melt the metallic coating powder while moving the energy beam and/or the metallic article to have a relative velocity of at or between about 15 meters/minute to about 60 meters/minute; and
cooling the melted metallic coating powder to form a coating layer on the surface of the metallic article.

2. The process of claim 1, wherein the energy beam is a laser.

3. The process of claim 1, wherein the metallic coating powder is fed coaxially with the energy beam.

4. The process of claim 1, wherein the coating layer has a thickness of about 10 microns to about 100 microns.

5. The process of claim 1, wherein greater than 50 wt. % of the metallic coating powder is melted by the energy beam.

6. The process of claim 1, wherein the metallic coating powder is at least partially melted before contacting the surface of the metallic particle.

7. The process of claim 1 further comprising forming additional coating layers by:
depositing additional metallic coating powder to the coating layer formed on the surface of the metallic article;
applying a second process energy beam to the additional metallic coating powder to at least partially melt the additional metallic coating powder while moving the energy beam and/or the metallic article to have a relative velocity of at or between about 15 meters/minute to about 60 meters/minute; and
cooling the melted additional metallic coating powder to form additional coating layers on the metallic article.

8. The process of claim 7, comprising forming no more than three coating layers on the surface of the metallic article.

9. The process of claim 1, wherein the metallic coating powder comprises, based on the total weight of the metallic coating powder, about 50 to about 70 wt. % of cobalt; and about 20 to 40 wt. % of chromium.

10. The process of claim 1, wherein the metallic coating powder comprises, based on the total weight of the coating powder, about 55 to 64 wt. % of cobalt; about 26 to 30 wt. % of chromium; about 1.2 to 3 wt. % of silicon, about 1 to about 1.3 wt. % of a carbide, and about less than 3 wt. % of iron.

11. The process of claim 1, wherein the metallic coating powder comprises particles having a size within the range of about 10 to about 100 microns.

12. The process of claim 1, wherein the metallic article is formed from one or more of the following: an iron-based alloy; a cobalt-based alloy; or a tungsten-based alloy.

13. The process of claim 1, wherein the metallic article comprises about 90 to about 99.5 wt. % of iron based on the total weight of the metallic article.

14. The process of claim 1, wherein the energy beam has a linear energy of about 2×10⁻³ kJ/mm to about 10×1.0⁻³ kJ/mm.

15. The process of claim 1, further comprising heat treating the coated metallic article.

16. A coated article manufactured by the process of claim 1.

17. An aircraft component comprising:
a substrate containing an iron-based alloy;
a coating disposed on a surface of the substrate, the coating being formed from a metallic powder comprising, based on the total weight of the metallic powder, about 50 to about 70wt % of cobalt; and about 20 to 40 wt. % of chromium.

18. The aircraft component of claim 17, wherein the coating has no more than three coating layers, each coating layer having a thickness of about 10 to about 100 microns.

19. The aircraft component of claim 17, wherein the aircraft component is an aircraft landing gear component.

20. An aircraft comprising the aircraft component of claim 17.
